(19) United States
(12) Patent Application Publication
(10) Pub. No.: US 2011/0273836 A1
(43) Pub. Date: Nov. 10, 2011

(54) RACK SERVER

(75) Inventors: Ji-Peng Xu, Shanghai City (CN); Jian-Feng Wu, Shanghai City (CN); Tsai-Kuei Cheng, Taipei City (TW)

(73) Assignee: INVENTEC CORPORATION, Taipei City (TW)

(21) Appl. No.: 12/796,945

(22) Filed: Jun. 9, 2010

(30) Foreign Application Priority Data
May 7, 2010 (CN) 201010170103.4

(51) Int. Cl. G06F 1/16; G06F 1/20

(52) U.S. Cl. 361/679.33; 361/679.48; 361/679.4

(57) ABSTRACT

A rack server includes a case, a fan module and two lobe frames. The case has a bottom board, two side walls, a first and a second end opposite to each other. The two side walls connect to the bottom board, and each of the side walls has a first and a second fixing portion respectively located at the first and the second end. The fan module is detachably disposed in the case and can optionally switch its orientation so that its outlet is towards the first or the second end. When the two lobe frames are optionally mounted at the two first fixing portions, the case is suitable to be installed into a server rack from the second end; when the two lobe frames are optionally mounted at the two second fixing portions, the case is suitable to be installed into the server rack from the first end.

### CROSS-REFERENCE TO RELATED APPLICATION

This application claims the priority benefit of China application serial no. 201010170103.4, filed on May 7, 2010. The entirety of the above-mentioned patent application is hereby incorporated by reference herein and made a part of specification.

### BACKGROUND OF THE INVENTION

1. Field of the Invention

The present invention generally relates to a server, and more particularly, to a rack server.

2. Description of Related Art

A server functions as a core computer serving every computer in a network system and is able to provide network users with the required disks and printing service, meanwhile provide each client terminal to share various resources within the network environment. The server has a fundamental architecture the same as a usual PC, that is, it comprises a central processing unit (CPU) located on a motherboard, memories and I/O devices. Buses are used to interconnect the above-mentioned parts, wherein north-bridge chip is used to connect the CPU and the memories and a south-bridge chip is used to connect the I/O devices. In terms of the case structure, a server has evolved in three stages: the earliest tower case structure, then the rack structure featuring function concentration, until the blade server with high density computation capability.

Taking a rack server as an example, the rack server is a server with an appearance following a unified design standard and is corporately used in association with a cabinet. In fact, the rack server is a tower server with the optimized structure, wherein the design principle mainly is to reduce the occupation of the server space as much as possible. Many special network apparatuses adopt the rack structure, and they are mostly flat ones so as to be ones like drawers, such as switcher, router or hardware firewall. A rack server has a width of 19″ and a height, wherein the height takes a unit of U (1 U=1.75″=44.45 mm). Usually a server has several height standards of 1 U, 2 U, 3 U, 4 U, 5 U and 7 U.

The size of a chassis also follows a universal industry standard, which has a different size from 22 U to 42 U. According to the U height, there are detachable slip trailers in a chassis, and the user can flexibly adjust the height according to the standard heights of their servers own so as to storage various network devices such as server, hub and diskette array cabinet. After placing the server, all the I/O cords are drawn out from the rear portion of the chassis (all the interfaces of a rack server are located at the rear portion as well). All the I/O cords are placed in a line tank of the chassis and adhered with notation marks for easier management.

However, since the I/Os of a server are disposed at the rear portion of the case, it does not facilitate cool-channel operation by the administrator of a client in data center stage or in rack stage.

### SUMMARY OF THE INVENTION

Accordingly, the present invention is directed to a rack server able to realize the front-rear switching of I/Os and hard disks.

The present invention provides a rack server suitable to be installed in a server rack. The rack server includes a case, a fan module and two lobe frames. The case has a bottom board, two side walls, a first end and a second end opposite to the first end. The two side walls connect to the bottom board, and each of the side walls has a first fixing portion located at the first end and a second fixing portion located at the second end. The fan module has an inlet and an outlet. The fan module is detachably disposed in the case and can optionally switch its orientation so that the outlet is towards the first end or towards the second end. The two lobe frames are optionally mounted at the two first fixing portions or at the two second fixing portions. When the two lobe frames are mounted at the two first fixing portions, the case is suitable to be installed into the server rack from the second end, while the outlet of the fan module is towards the second end; when the two lobe frames are mounted at the two second fixing portions, the case is suitable to be installed into the server rack from the first end, while the outlet of the fan module is towards the first end.

In an embodiment of the present invention, each of the lobe frames has a third fixing portion and a retaining portion structurally perpendicular to the third fixing portion, and all the lobe frames are respectively mounted at the two side walls through the third fixing portions. When the case is installed into the server rack, the retaining portions are mounted at the server rack.

In an embodiment of the present invention, the case further has an I/O interface panel located at the second end and is connected to the bottom board and the two side walls.

In an embodiment of the present invention, the rack server further has a motherboard disposed at the bottom board and leans against the I/O interface panel, wherein the motherboard has a plurality of I/O interfaces exposed from the I/O interface panel and suitable to connect to the external devices from the second end.

In an embodiment of the present invention, the case further has a first hard disk bay, wherein the first hard disk bay is located at the first end and has a plurality of hard disk installation openings suitable to install or uninstall the hard disks from the first end.

In an embodiment of the present invention, the fan module includes a fans-supporting frame and a plurality of fans, wherein the fans are installed in the case through the fans-supporting frame.

In an embodiment of the present invention, each of the side walls has a fourth fixing portion located between the first end and the second end, wherein the fans-supporting frame is fixed at the fourth fixing portion.

In an embodiment of the present invention, the fans-supporting frame includes a first supporting frame and a second supporting frame, and the fans are disposed between the first supporting frame and the second supporting frame.

In an embodiment of the present invention, the rack server further includes a second hard disk module, wherein the second hard disk module includes at least a second hard disk bay and at least a second hard disk, the second hard disk bay is located in the case and disposed on the bottom board, and the second hard disk is installed at the second hard disk bay and lays on the bottom board.

In an embodiment of the present invention, the rack server further includes an external DC power disposed outside the case and providing power to the first hard disks and the second hard disk.

The rack server of the present invention can be optionally installed at the first end or the second end through the two lobe frames thereof, so that the rack server can be optionally installed on the rack with the outward first end or the outward second end.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a decomposition diagram of a rack server according to an embodiment of the present invention.

FIG. 2 is an assembly diagram of the rack server of FIG. 1 where the lobe frames are fixed at the first end.

FIG. 3 is an assembly diagram of the rack server of FIG. 1 where the lobe frames are fixed at the second end.

FIG. 4 is a localized inside diagram of the rack server of FIG. 1.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

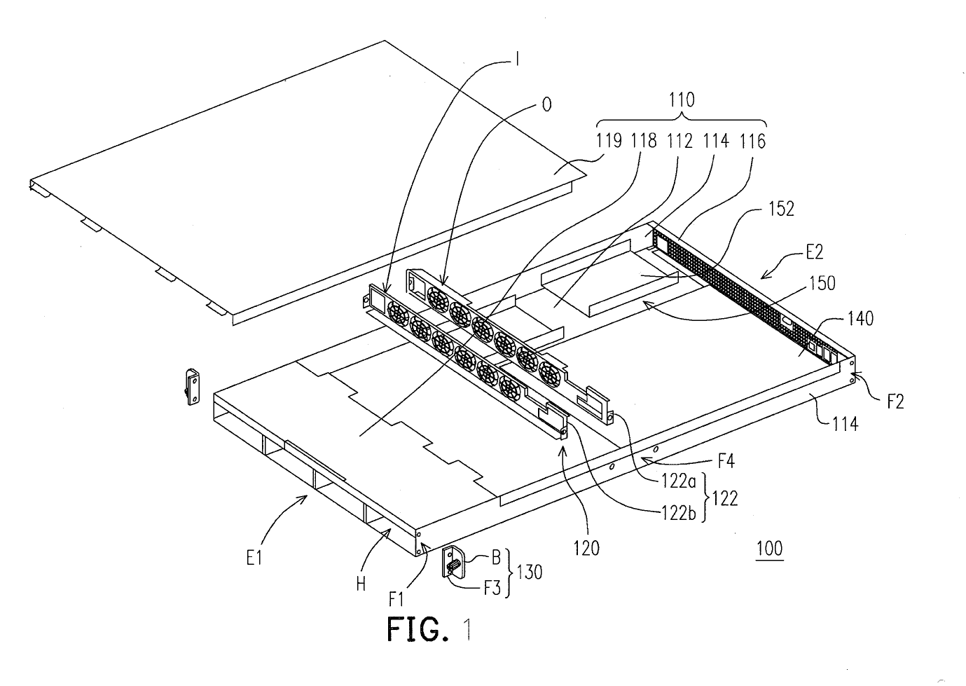

FIG. 1 is a decomposition diagram of a rack server according to an embodiment of the present invention. A rack server 100 is suitable to be installed in a server rack (not shown). The rack server 100 includes a case 110, a fan module 120 and two lobe frames 130. The case 110 has a bottom board 112, two side walls 114 and a first end E1 and a second end E2 opposite to the first end E1. The two side walls 114 are connected to the bottom board 112, and each of the side walls 114 has a first fixing portion F1 located at the first end E1 and a second fixing portion F2 located at the second end E2. In the embodiment, the width of the case 110 can be defined as 448 mm.

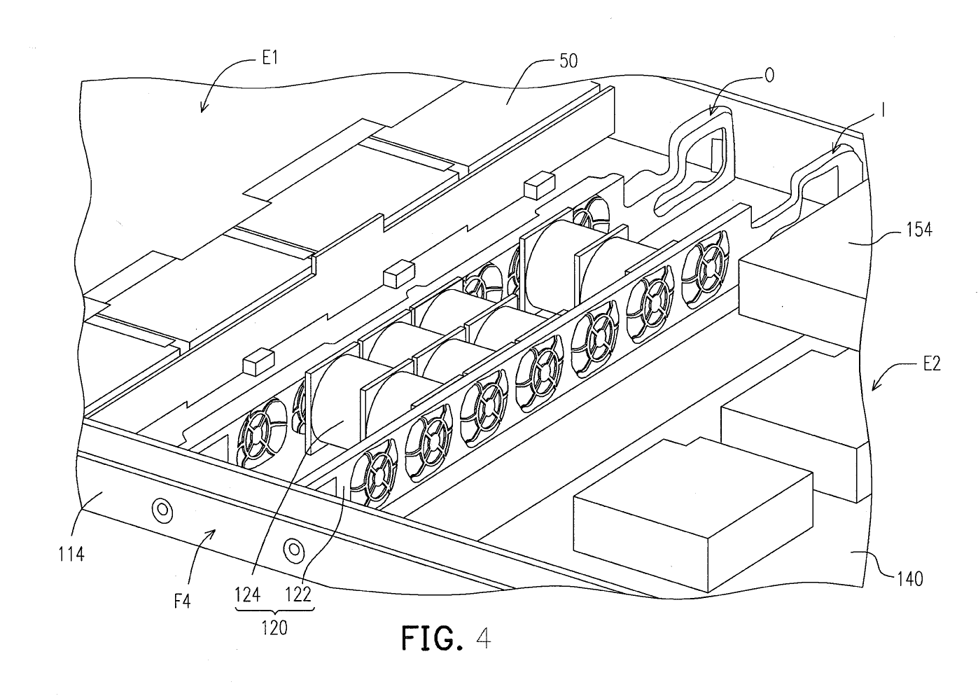

The fan module 120 has an inlet I and an outlet O. The fan module 120 can be detachably disposed in the case 110 and optionally oriented so that the outlet O is towards the first end E1 or towards the second end E2. In the embodiment, the fan module 120 includes a fans-supporting frame 122 and a plurality of fans 124 (as shown in FIG. 4). The fans 124 are installed in the case 110 through the fans-supporting frame 122.

Furthermore, the fans-supporting frame 122 includes a first supporting frame 122a and a second supporting frame 122b, and the fans 124 are disposed between the first supporting frame 122a and the second supporting frame 122b (as shown in FIG. 4). In addition, each of the side walls 114 has, for example, a fourth fixing portion F4 located between the first end E1 and the second end E2. The fans-supporting frame 122 can be detachably fixed at the fourth fixing portion F4.

The two lobe frames 130 are optionally mounted at the two first fixing portions F1 or at the two second fixing portions F2. In the embodiment, each of the lobe frames 130 in terms as structure has a third fixing portion F3 and a retaining portion B perpendicular to the third fixing portion F3. All the lobe frames 130 are respectively mounted at the two side walls 114 through the third fixing portions F3. When the case 110 is installed into the server rack, the retaining portion B leans against and is installed at the server rack.

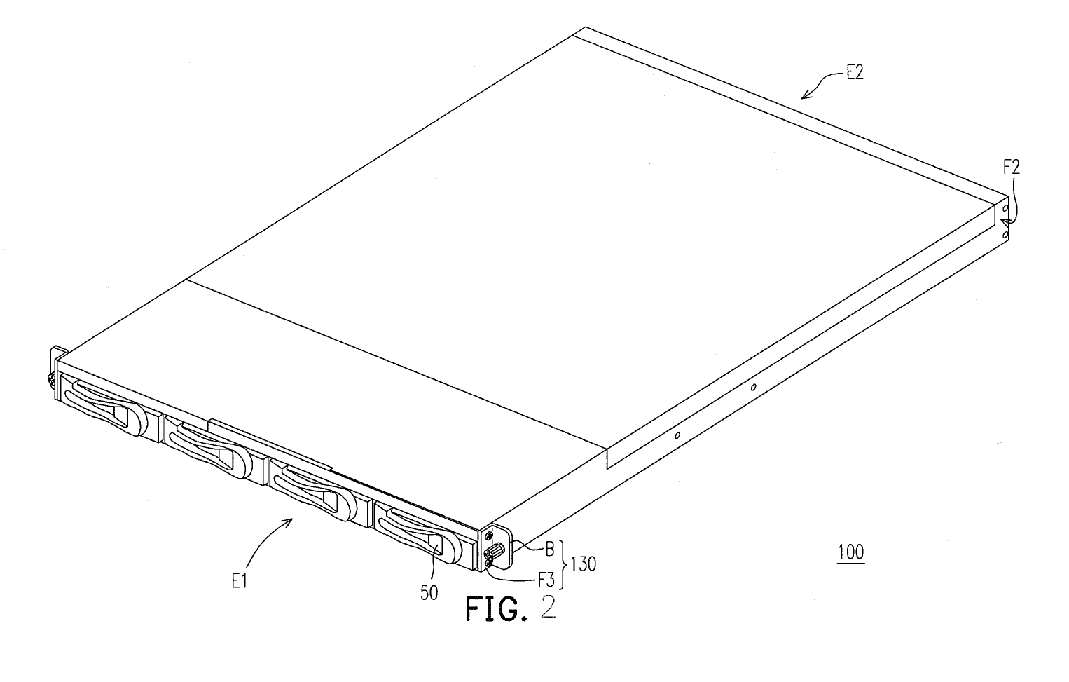

FIG. 2 is an assembly diagram of the rack server of FIG. 1 where the lobe frames are fixed at the first end. Referring to FIGS. 1 and 2, when the two lobe frames 130 are mounted at the two first fixing portions F1, the case 110 is suitable to be installed into the server rack from the second end E2 and the fan module 120 at the time is so oriented that the outlet O thereof is towards the second end E2, and the first end E1 of the case 110 is exposed outside the server rack.

In the embodiment, the case 110 can further have a first hard disk bay 118, wherein the first hard disk bay 118 is located at the first end E1 and has a plurality of hard disk installation openings H, which is suitable to install or uninstall a plurality of first hard disks 50 from the first end E1, wherein the quantities of the hard disk installation openings H and the first hard disks 50 are, for example, 4.

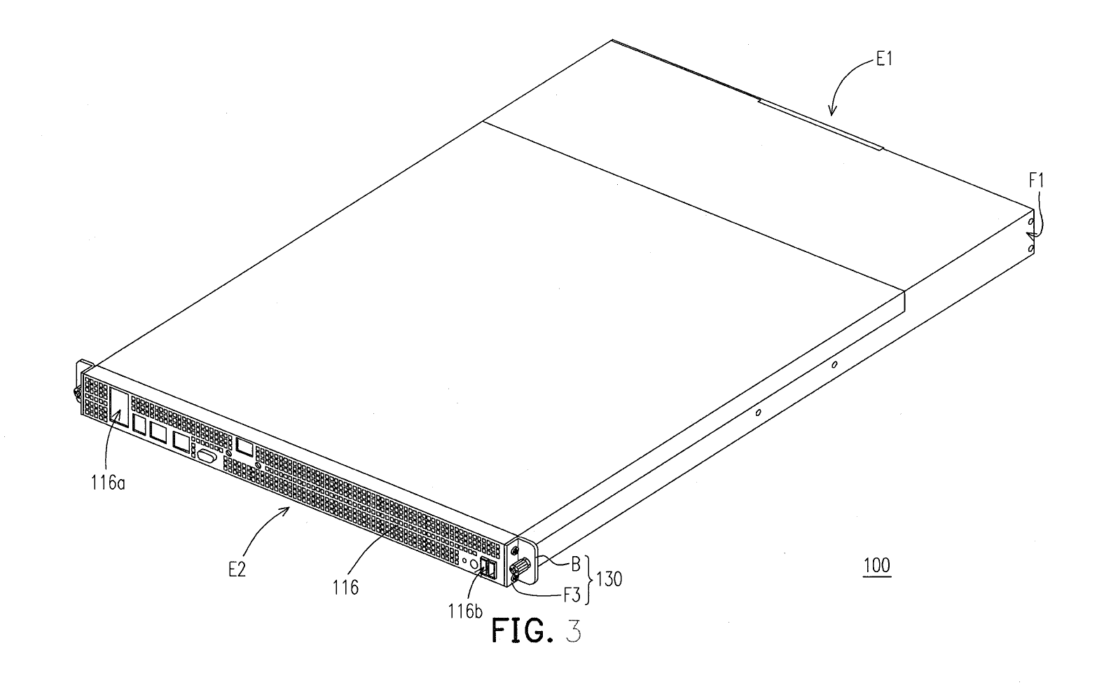

FIG. 3 is an assembly diagram of the rack server of FIG. 1 where the lobe frames are fixed at the second end. Referring to FIG. 3, when the two lobe frames 130 are mounted at the two second fixing portions F2, the case 110 is suitable to be installed into the server rack from the first end E1 and the fan module 120 at the time is so oriented that the outlet O thereof is towards the first end E1, and the second end E1 of the case 110 is exposed outside the server rack.

It should be noted that, since the two lobe frames 130 are designed completely symmetry and can adopt anti-slip screws to lock, so that it is convenient to change the front-rear orientation of the case 110, which can realize the front-rear switching between the I/Os and the hard disks. In addition, the fixing structure of the fans-supporting frame 122 onto the two side walls 114 is also symmetrically designed. As a result, the fans 124 together with the fans-supporting frame 122 can be installed in 180° rotation, which increases the suitability of the fan module 120.

In the embodiment, the case 110 can have an I/O interface panel 116. The I/O interface panel 116 is located at the second end E2 and connected to the bottom board 112 and the two side walls 114. In addition, the I/O interface panel 116 can have a plurality of I/O openings 116a. The case 110 can further have a case cover 119 covering the space enclosed by the bottom board 112, the two side walls 114, the first hard disk bay 118 and the I/O interface panel 116.

FIG. 4 is a localized inside diagram of the rack server of FIG. 1. Referring to FIGS. 1 and 4, the rack server 100 can further have a motherboard 140 disposed at the bottom board 112 and leaning against the I/O interface panel 116. The motherboard 140 has a plurality of I/O interfaces (not shown), and the I/O openings 116a exposed out of the I/O interface panel 116 is suitable to connect to external equipments (not shown) from the second end E2.

Moreover, the rack server 100 can further include a second hard disk module 150. The second hard disk module 150 includes at least a second hard disk bay 152 and at least a second hard disk 154. The second hard disk bay 152 is located in the case 110 and disposed on the bottom board 112. The second hard disk 154 is installed at the second hard disk bay 152 and lays down on the bottom board 112. In the embodiment, the quantities of the second hard disk bay 152 and the second hard disk 154 can be respectively two, i.e., the rack server 100 is able to support six 3.5″ hard disks.

In addition, the I/O interface panel 116 can further have a DC power interface 116b (FIG. 3), and the rack server 100 further includes an external DC power (not shown) disposed outside the case 110. The first hard disks 50, the motherboard 140 and the second hard disk 154 are electrically connected to the external DC power through, for example, the DC power interface 116b so that the external DC power is able to provide the first hard disks 50, the motherboard 140 and the second hard disk 154 with power. In the embodiment, the external DC power is, for example, an external transformer used for common notebooks to be connected to a socket (not shown) so as to provide the rack server 100 with power.

In summary, the two lobe frames of the rack server of the present invention can be optionally mounted at the first end or the second end. Therefore, the rack server can be installed on the rack with the outward first end or the outward second end. In this way, the I/O interface panel can be exposed out of the rack, which facilitates cool-channel operation by the administrator. In addition, the rack server can employ an additional second hard disk to fully utilize the rack space.

It will be apparent to those skilled in the art that the descriptions above are several preferred embodiments of the present invention only, which does not limit the implementing range of the present invention. Various modifications and variations can be made to the structure of the present invention without departing from the scope or spirit of the invention.

What is claimed is:

1. A rack server suitable to be installed in a server rack, comprising:
a case, having a bottom board, two side walls, a first end and a second end opposite to the first end, wherein the two side walls connect to the bottom board, and each of the side walls has a first fixing portion located at the first end and a second fixing portion located at the second end;
a fan module, having an inlet and an outlet, wherein the fan module is detachably disposed in the case and optionally switches its orientation so that the outlet is towards the first end or towards the second end; and
two lobe frames, optionally mounted at the two first fixing portions or at the two second fixing portions;
when the two lobe frames are mounted at the two first fixing portions, the case is suitable to be installed into the server rack from the second end, while the outlet of the fan module is towards the second end;
when the two lobe frames are mounted at the two second fixing portions, the case is suitable to be installed into the server rack from the first end, while the outlet of the fan module is towards the first end.

2. The rack server as claimed in claim 1, wherein each of the lobe frames has a third fixing portion and a retaining portion structurally perpendicular to the third fixing portion, and all the lobe frames are respectively mounted at the two side walls through the third fixing portions, and when the case is installed into the server rack, the retaining portions are mounted at the server rack.

3. The rack server as claimed in claim 1, wherein the case further has an I/O interface panel located at the second end and is connected to the bottom board and the two side walls.

4. The rack server as claimed in claim 1, further comprising:
a motherboard, disposed at the bottom board and leaning against the I/O interface panel, wherein the motherboard has a plurality of I/O interfaces exposed from the I/O interface panel and suitable to connect to the external devices from the second end.

5. The rack server as claimed in claim 1, wherein the case further has a first hard disk bay, the first hard disk bay is located at the first end and has a plurality of hard disk installation openings suitable to install or uninstall a plurality of hard disks from the first end.

6. The rack server as claimed in claim 1, wherein the fan module comprises:
a fans-supporting frame and a plurality of fans, wherein the fans are installed in the case through the fans-supporting frame.

7. The rack server as claimed in claim 6, wherein each of the side walls has a fourth fixing portion located between the first end and the second end, and the fans-supporting frame is fixed at the fourth fixing portion.

8. The rack server as claimed in claim 6, wherein the fans-supporting frame comprises a first supporting frame and a second supporting frame, and the fans are disposed between the first supporting frame and the second supporting frame.

9. The rack server as claimed in claim 1, further comprising:
a second hard disk module, comprising:
at least a second hard disk bay, located in the case and disposed on the bottom board; and
at least a second hard disk, installed at the second hard disk bay and laying on the bottom board.

10. The rack server as claimed in claim 1, further comprising:
an external DC power, disposed outside the case.
